(19) United States
(12) Patent Application Publication
(10) Pub. No.: US 2016/0086189 A1
(43) Pub. Date: Mar. 24, 2016

(54) Item Registration Services

(71) Applicant: Amazon Technologies, Inc., Reno, NV (US)

(72) Inventor: Sudarshan Anand Chitre, Redmond, WA (US)

(21) Appl. No.: 14/495,325

(22) Filed: Sep. 24, 2014

(51) Int. Cl. G06Q 30/00; G06Q 30/06

(52) U.S. Cl. CPC G06Q 30/01; G06Q 30/0633

(57) ABSTRACT

Technologies are described herein for providing item registration services to customers. A customer of an electronic marketplace system is provided with functionality to submit a request to register an item when purchasing the item through an electronic marketplace system. The customer may choose assisted direct registration for the item using his/her identity information or indirect registration using identity information of the electronic marketplace system. Once the purchase order is received and has been processed, a registration request may be generated based on item information and customer information contained in the purchase order, and submitted to the corresponding manufacturer. When indirect registration is selected, the customer information is replaced with the information of the electronic marketplace system before the registration request is submitted to the manufacturer. Additional services and functionality, such as service request processing, message forwarding and filtering, may also be provided by the electronic marketplace system for the registered items.

### BACKGROUND

Registering a product with the manufacturer of the product can bring several benefits to a customer, such as receiving recall or safety information about the product, claiming theft insurance for the product, participating in class action lawsuits involving the product, and so on. Many customers do not, however, register purchased products due to various factors. For example, some customers may feel that it is too much trouble to collect and enter the various types of information typically required to register a product with the manufacturer. Some other customers might choose not to register their products because they often receive unwanted postal or electronic mail from manufacturers after they provide their contact information to the manufacturer during product registration. Another factor that may cause customers to refrain from registering their products is the concern that their identity information may be inadvertently exposed to a third party. Other concerns might also discourage customers from registering a purchased product with the manufacturer of the product.

As a result of some or all of the concerns identified above, a large number of customers may not take advantage of the benefits of product registration. Instead, some customers may rely on other inefficient ways to obtain useful information, such as obtaining product recall information through press releases from recalling government agencies, while others may not obtain important information that may affect them at all.

The disclosure made herein is presented with respect to these and other considerations.

### BRIEF DESCRIPTION OF THE DRAWINGS

FIG. 1A is a block diagram showing aspects of the operation of one illustrative embodiment disclosed herein for providing item registration services to customers;

FIG. 1B is a block diagram showing aspects of the operation of another illustrative embodiment disclosed herein for providing item registration services to customers;

FIG. 2 is a block diagram illustrating a number of data elements maintained in a manufacturer data store and in a registered item data store, according to embodiments presented herein;

FIGS. 3A and 3B are flow diagrams illustrating aspects of one embodiment disclosed herein for automatically registering an item for a customer, according to one embodiment disclosed herein;

FIG. 4 is a pictorial diagram showing an illustrative user interface provided in one embodiment disclosed herein that enables a customer to submit a request to automatically register an item;

FIG. 5 is a flow diagram illustrating aspects of one embodiment disclosed herein for handling a service request from a customer regarding a registered item;

FIG. 6 is a flow diagram illustrating aspects of one embodiment disclosed herein for forwarding a message from a manufacturer of an item to registered customers; and

FIG. 7 is a block diagram showing an illustrative computer hardware architecture for implementing a computing device utilized to implement aspects of the various embodiments presented herein.

### DETAILED DESCRIPTION

The following detailed description is directed to technologies for providing registration services to customers for purchased items (e.g., goods and/or services). Utilizing the technologies described herein, a customer can request to automatically register an item purchased from an electronic marketplace or other networked merchant or commerce system (referred to interchangeably herein as an “electronic marketplace system”) with the item's manufacturer or other source (referred to interchangeably herein as a “manufacturer”), without the effort of entering customer or item information required by traditional registration processes. For example, the customer may be provided with an option to register the item by allowing the electronic marketplace system (which is not operated by or otherwise under the control or direction of the manufacturer of the item) to release identity information to the manufacturer of the item (referred to herein as “assisted direct registration”). Alternatively, or in addition, the customer may be provided with an option to register the item with the electronic marketplace system, which in turn, may register the item with the manufacturer (referred to herein as “indirect registration”). Such registration would utilize identity information of the electronic marketplace, thereby avoiding release of personal information of the customer to the manufacturer. Indirect registration may also enable the electronic marketplace system to filter messages sent by manufacturers before forwarding the messages to corresponding customers so that unwanted message may be prevented from reaching the customers. The customer or the electronic marketplace, in either registration scenario, may be referred to as a “registrant.”

According to one aspect presented herein, a computer-implemented method and system are disclosed for automatically registering an item purchased or otherwise acquired by a customer through an electronic marketplace that is not operated by or otherwise under the control or direction of the manufacturer of the item. In particular, a customer may request to purchase an item through an electronic marketplace system. In response to receiving such a purchase request, the electronic marketplace system may present a user interface to the customer that enables the customer to place an order to purchase or otherwise acquire the item and to request automatic registration of the item through the electronic marketplace system. Accordingly, the customer may receive the benefits of item registration (e.g., warranties, recall notices, future discounts, etc.) from the manufacturer of the item as if the customer had registered directly with the manufacturer without the assistance or involvement of the electronic marketplace system.

Once the electronic marketplace system receives an order for an item from the customer, the electronic marketplace system may process and cause the order to be fulfilled. The electronic marketplace system may further determine if the customer has requested to automatically register the item through the electronic marketplace system. If the electronic marketplace system determines that the customer has requested to register the item, the electronic marketplace system may further identify any information required to register the item. Such information may be obtained from a manufacturer data store configured to store various types of information associated with manufacturers of items sold by the electronic marketplace system. Such information may include, but is not limited to, basic information about the manufacturers, information regarding items manufactured by each of the manufacturers, and other types of information to be submitted for registering an item with the corresponding manufacturer.

For example, a manufacturer may require item data including various types of data associated with the item to be provided during the registration, such as an identifier of the item, e.g., a name of the item, the type of the item, the model number of the item, the Universal Product Code (“UPC”), other unique identifier of the item, and the like. For some types of items, a description of the item may also be needed to register the item. In such a scenario, the item description (which may include an identifier) may be submitted by a fulfillment center when preparing the item for shipping or by the customer submitting such information once the customer receives the item.

The manufacturer of the item may further require that customer data identifying the customer be submitted when registering the item. Such customer data may also be referred to as “registrant data.” If the customer has selected the option to directly register the item with the assistance of the electronic marketplace, the electronic marketplace will provide the customer's identity information (e.g., as stored in the customer's account or in a registration data store maintained by, or otherwise associated with, the electronic marketplace system) as the registrant data. If the customer has selected the option to indirectly register the item, the electronic marketplace system will register the item with the manufacturer as a registration proxy for the customer, utilizing identity information of the electronic marketplace (e.g., domain name, business name, business address, etc.), thereby avoiding release of personal information of the customer to the manufacturer. In either case, the identity information of the customer, such as the name, the address, and/or the contact information of the customer, may be readily available to the electronic marketplace system, and thus, may be provided to the manufacturer without extra burden on the customer.

Based on the collected item data and customer data, registration instructions (which may be referred to herein as a registration request) may be generated and sent to a computing system associated with the manufacturer of the item. In further embodiments, data associated with the registration of the item and data associated with the customer who purchased the item from the electronic marketplace may be stored in a registration data store maintained by the electronic marketplace system.

Depending on the process (e.g., assisted direct registration or indirect registration) selected by a customer when registering an item, further communication regarding the item may be performed directly between the customer and the manufacturer or through the electronic marketplace system. For example, if the customer has selected assisted direct registration for an item, the manufacturer may utilize the identity information of the customer provided in the registration instructions to directly contact the customer for future communications, such as sending recall announcements, item promotion information, item advertisements, and the like. Similarly, the customer may also directly contact the manufacturer for any services related to the item, such as repair, exchange, or return of the item. As used herein, the term “item,” in addition to having its ordinary meaning, is used interchangeably to refer to an item itself (e.g., a particular product) and to its description or representation in a computer system or electronic catalog. As will be apparent from the context in which it is used, the term is also sometimes used herein to refer only to the item itself or only to its representation in the computer system.

For those customers who have chosen to indirectly register their items without releasing his/her information to the manufacturer, the manufacturer cannot directly contact them and may instead send messages intended to these customers to the electronic marketplace system. The electronic marketplace system may identify these customers, for example, utilizing data stored in the registration data store, and forward the messages to the customers according to preferences specified by individual customers.

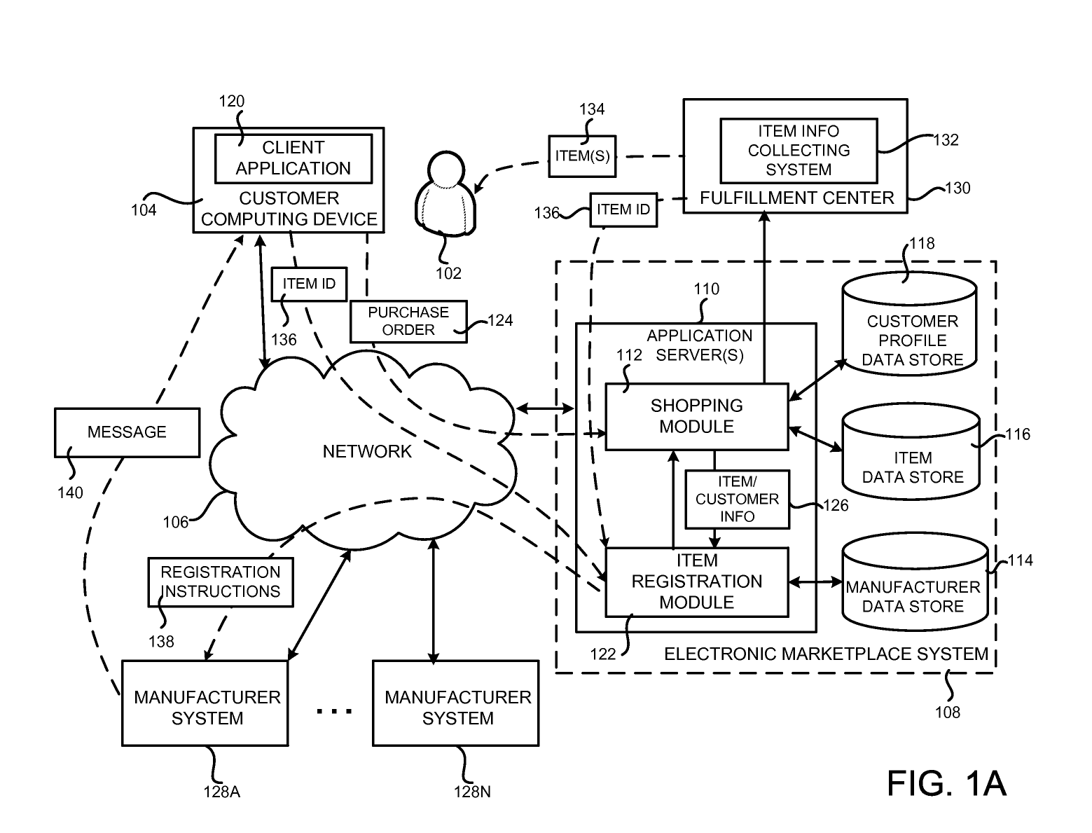

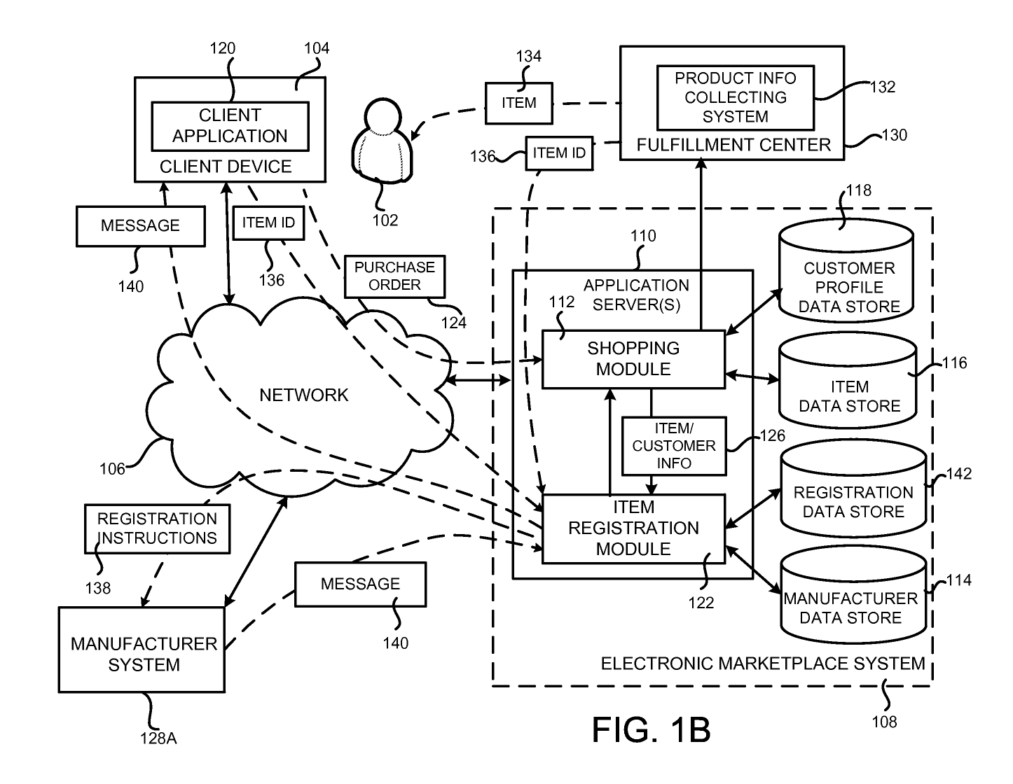

In further embodiments, the electronic marketplace system may provide additional functionality to permit a customer to request services for their registered item from the manufacturer. For example, a customer may submit a service request for an item purchased from and registered through the electronic marketplace system to request a manufacturer service covered by a warranty of the item, such as an item repair service, an item exchange service, and/or an item return service. Based on the request submitted by the customer, the electronic marketplace system may identify service policies provided by the manufacturer, collect additional information required by the manufacturer, and submit a service request to the manufacturer based on the service policies and/or the collected information. Similarly, other services or functionality with regard to item registration may be provided by the electronic marketplace system to the customers. Additional details regarding the various software components and processes described briefly above for providing the item registration services will be presented below with regard to FIGS. 1-7.

It should be appreciated that the subject matter presented herein may be implemented as a computer process, a computer-controlled apparatus, a computing system, or an article of manufacture, such as a computer-readable storage medium. While the subject matter described herein is presented in the general context of program modules that execute on one or more computing devices, those skilled in the art will recognize that other implementations may be performed in combination with other types of program modules. Generally, program modules include routines, programs, components, data structures, and other types of structures that perform particular tasks or implement particular abstract data types.

Those skilled in the art will also appreciate that aspects of the subject matter described herein may be practiced on or in conjunction with other computer system configurations beyond those described herein, including multiprocessor systems, microprocessor-based or programmable consumer electronics, minicomputers, mainframe computers, handheld computers, wearable computing devices, personal digital assistants, electronic book readers, mobile telephone devices, tablet computing devices, special-purposed hardware devices, network appliances, and the like. The embodiments described herein may be practiced in distributed computing environments, where tasks may be performed by remote computing devices that are linked through a communications network. In a distributed computing environment, program modules may be located in both local and remote memory storage devices.

In the following detailed description, references are made to the accompanying drawings that form a part hereof, and that show, by way of illustration, specific embodiments or examples. The drawings herein are not drawn to scale. Like numerals represent like elements throughout the several figures (which may be referred to herein as a “FIG.” or “FIGS.”).

FIG. 1A is a block diagram showing aspects of the operation of one illustrative embodiment disclosed herein for providing assisted direct item registration services to customers, according to one embodiment. As shown in FIG. 1A, a customer 102 may use a customer computing device 104 to access an electronic marketplace system 108 across a network 106. The customer 102 may be an individual or entity that desires to browse, research, review, and/or purchase items offered for sale via the electronic marketplace system 108. Items may include physical goods, such as a TV, a camera, a bike, or a CD; digital media items, such as a downloadable MP3 audio track or a streaming movie; event tickets; media or service subscriptions; or any other goods or services which can be purchased by the customer 102.

The customer computing device 104 may be a personal computer (“PC”), a desktop workstation, a laptop or tablet, a notebook, a personal digital assistant (“PDA”), an electronic book reader, a smartphone, a game console, a set-top box, a consumer electronics device, a wearable computing device, a server computer, or any other computing device capable of connecting to the network 106 and communicating with the electronic marketplace system 108. The network 106 may be any wired network, wireless network, or combination thereof. In addition, the network 106 may be a personal area network, local area network, wide area network, cable network, satellite network, cellular telephone network, or combination thereof. In addition, the network 106 may be an over-the-air broadcast network (e.g., for radio or television) or a publicly accessible network of linked networks, possibly operated by various distinct parties, such as the Internet. In some embodiments, the network 106 may be a private or semi-private network, such as a corporate or university intranet. The network 106 may include one or more wireless networks, such as a Global System for Mobile Communications (GSM) network, a Code Division Multiple Access (CDMA) network, a Long Term Evolution (LTE) network, or any other type of wireless network. The network 106 can use protocols and components for communicating via the Internet or any of the other aforementioned types of networks, such as the Hypertext Transfer Protocol (“HTTP”). Protocols and components for communicating via the Internet or any of the other aforementioned types of communication networks are well known to those skilled in the art of computer communications and thus, need not be described in more detail herein.

The electronic marketplace system 108 may include a number of application servers 110 that provide various electronic shopping services to the customer computing device 104 over the network 106. The customer 102 may use a client application 120 executing on the customer computing device 104 to access and utilize the shopping services provided by the application servers 110. According to one embodiment, the client application may be a browser application. The browser application may exchange data with the application servers 110 in the electronic marketplace system 108 using the HTTP over the network 106. Alternatively, the client application 120 may be a client-side software application dedicated to providing the shopping services offered by the application servers 110. The client application 120 may utilize any number of communication methods known in the art to communicate with the electronic marketplace system 108 and/or the application servers 110 across the network 106, including remote procedure calls, web services, remote file access, proprietary client-server architectures, and the like.

The application servers 110 may execute a number of modules in order to provide the electronic shopping services to the customer 102. The modules may execute on a single application server 110 or in parallel across multiple application servers 110 in the electronic marketplace system 108. In addition, each module may consist of a number of subcomponents executing on different application servers 110 or other computing devices in the electronic marketplace system 108. The modules may be implemented as hardware or software executed by hardware.

According to one embodiment, a shopping module 112 may execute on the application servers 110. The shopping module 112 provides electronic shopping functionality through which the customer 102 may browse and purchase items available from the electronic marketplace system 108. For instance, the shopping module 112 may retrieve information regarding a particular item offered for sale by the electronic marketplace from an item data store 116 and generate a network page for rendering at the customer computing device 104 (or more specifically, generate instructions for rendering the network page at the customer computing device 104). The network page may contain information describing the item (e.g., an item page). The shopping module 112 may then transmit the instructions for generating the item page over the network 106 to the client application 120 executing on the customer computing device 104. The shopping module 112 may also provide an electronic shopping cart containing items that the customer 102 intends to purchase, and further provide a checkout user interface, through which a customer 102 may place a purchase order 124 to complete the purchase of the items in the electronic shopping cart.

Once the shopping module 112 receives the purchase order 124, the shopping module 112 may process the purchase order 124 and inform a fulfillment center 130 to fulfill the purchase order 124. Personnel at the fulfillment center 130 may then retrieve the items 134 from the inventory, pack and ship the items 134 to the customer 102. An item information collecting system 132 may also be utilized at the fulfillment center 130 to collect information regarding the items 134 that are being processed, such as the item name, the item type, the item model number, the quantity of the items 134 in the package to be shipped to the customer 102, and other information about the items 134.

For some items, such as consumer electronics devices, home appliances, tools, toys, baby equipment, exercise equipment, and the like, it may be beneficial or desirable for the customer to register the items with their corresponding manufacturers in order to, for example, receive recall or safety information about the item, claim theft insurance for the item, and/or participate in class action lawsuits involving the item. In order to facilitate the registration of items, the electronic marketplace system 108 may further provide item registration services that enable the customer 102 to automatically register the items 134 purchased through the electronic marketplace system 108, and to further manage the item registrations.

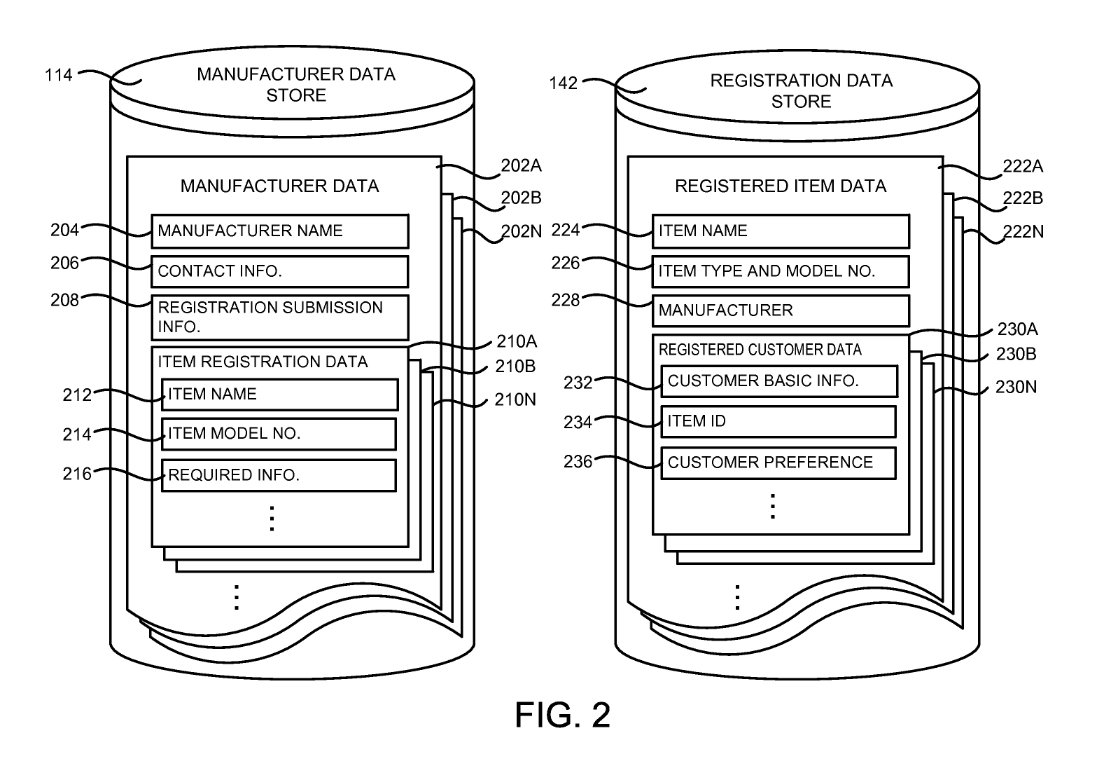

In embodiments, an item registration module 122 may execute on the application servers 110 to provide various item registration services. The item registration module 122 may maintain a manufacturer data store 114 to store data associated with manufacturers whose items are offered for sale through the electronic marketplace system 108 and who agree to accept item registrations from the electronic marketplace system 108. The manufacturer data store 114 may further include registration information for the items 134, such as item data describing the item to be registered and customer data describing the registered customer. More details regarding the data stored in the manufacturer data store 114 will be described below in regard to FIG. 2.

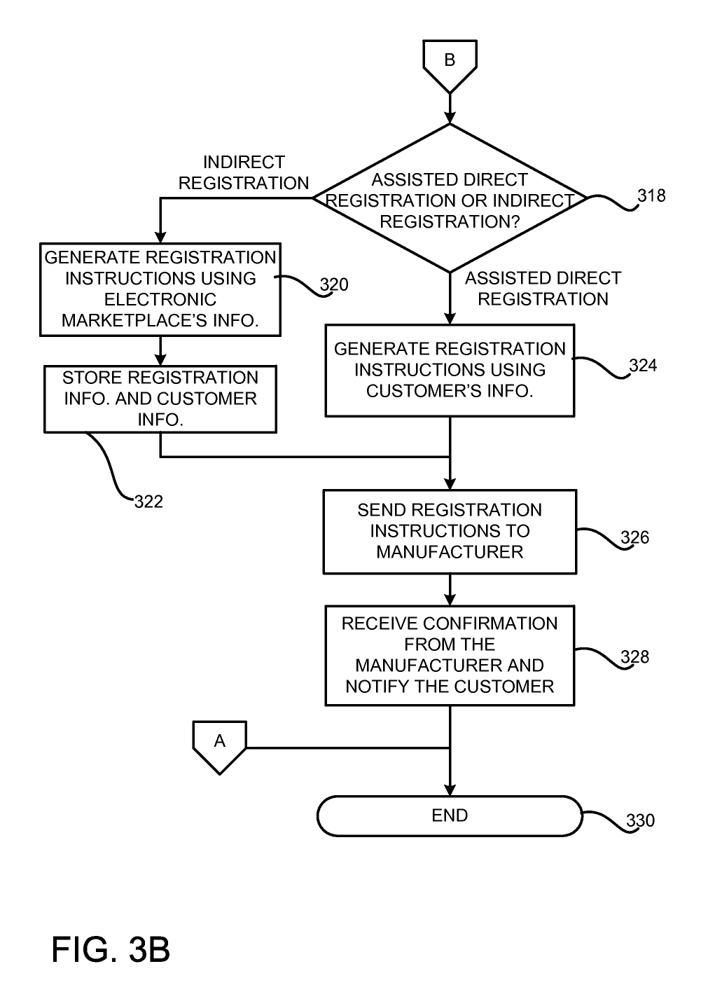

The item registration module 122 may retrieve data from the manufacturer data store 114 to identify the qualified items that can be registered through the electronic marketplace system 108 and send such information to the shopping module 112. The shopping module 112 may utilize such information to generate a user interface that enables the customer 102 to request registration of qualified items that he/she is about to purchase through the electronic marketplace system 108. For example, the shopping module 112 may include one or more user interface controls in a checkout user interface presented to the customer 102 to enable the customer 102 to make a selection to automatically register the qualified items 134 along with the purchase. Once the customer 102 submits the purchase order 124 for the items, the request for registration may be automatically submitted to the electronic marketplace system 108 for further processing. An illustrative user interface enabling a customer to submit a request for item registration along with a purchase order is illustrated in FIG. 4 and will be described in detail below.

When the request for registration is received, the shopping module 112 may further collect information 126 with regard to the items to be registered and the customer 102. If the item/customer information 126 is readily available from the purchase order 124, the shopping module 112 may extract such information and forward it to the item registration module 122. Otherwise, the shopping module 112 or the item registration module 122 may retrieve item information from the item data store 116, and/or retrieve customer information from a customer profile data store 118 where various types of data associated with the customer 102 may be stored, such as the name of the customer 102, the address of the customer 102, the telephone number of the customer 102, email address of the customer 102, and the like.

The item registration module 122 may further reformat the received item/customer information 126 according to any requirements of the corresponding manufacturer and generate registration instructions 138 for each of the items requested for registration. The generated registration instructions 138 may be submitted to the corresponding manufacturer systems 128A-128N (which may be referred to herein individually as a manufacturer system 128 or collectively as manufacturer systems 128), for example, through an application programming interface (“API”) exposed by the manufacturer systems 128.

For items such as TVs, computers, and/or cameras, an item identifier (“ID”) 136, such as a serial number that uniquely identifies an item 134, may be required by the manufacturer for registering the item. To obtain such information, the item information collecting system 132 may be utilized at the fulfillment center 130 to further collect the item ID 136 and send it to the item registration module 122. For example, the item ID 136 may be obtained at the fulfillment center 130 by scanning a barcode that represents the item ID 136 from outside the packaging of the item, if available.

In scenarios when the item ID 136 is not accessible from outside the item packaging, the item ID 136 may be obtained and submitted by the customer 102 when he/she receives the item 134. For example, the customer 102 may utilize a camera or a scanner to capture an image of the item ID 136, and submit such an image to the item registration module 122 through the client application 120, for example. Alternatively, the customer 102 may manually enter the item ID 136 and submit it to the item registration module 122. It should be understood that these examples are only illustrative and should not be construed as limiting. Various other mechanisms may be also utilized by the customer 102 to obtain and submit the item ID 136.

Once the item ID 136 is received, the item registration module 122 may include it in the registration instructions 138 for the item and submit it to the corresponding manufacturer system 128. Since, in this embodiment the identity information of the customer 102 may be included in the registration instructions 138, the manufacturer may utilize such identity information to directly contact the customer 102 for any further communication, such as sending a message 140 to the customer 102.

FIG. 1B is a block diagram showing aspects of the operation of another illustrative embodiment disclosed herein for providing indirect item registration services. In this embodiment, the electronic marketplace system 108 may provide an item registration service that enables the customer 102 to indirectly register an item 134 that he/she purchased through the electronic marketplace system 108 without releasing the personal information of the customer 102 to the manufacturer of the item 134. The modules and entities illustrated in FIG. 1B operate in a manner similar to that described above with regard to FIG. 1A except for the item registration module 122. In this embodiment, the item registration module 122 may generate a registration instructions 138 including item data generated based on the item information contained in the item/customer information 126. The customer data in the registration instructions 138, however, may be generated based on the identity information of the electronic marketplace, rather than the identity information of the customer 102. The information of the customer 102 along with the information contained in the registration instructions 138 may be stored in a registration data store 142 maintained by the electronic marketplace system 108.

From the manufacturer's perspective, the electronic marketplace is the registered customer, or the registrant, for the item 134 and, thus, messages 140 intended for the actual customers 102 may be sent to the electronic marketplace system 108. Based on the received message 140, the item registration module 122 may identify the corresponding customers 102 using data stored in the registration data store 142 and retrieve the contact information for those customers 102. The message 140 may then be forwarded to the corresponding customer 102. In some embodiments, the item registration module 122 may further retrieve customer preferences for the customers 102 and filter the message 140 according to the customer preferences before forwarding it to the customers 102.

In addition, the electronic marketplace system 108 may store the messages 140 and/or other data associated with interactions between the manufacturer and the customers 102 in the registration data store 142. Such data may be utilized to analyze the quality of the items 134, the reputation of the manufacturers, and/or other aspects of the item 134 and/or the manufacturer. For example, a message 140 containing a recall announcement for an item 134 manufactured by a manufacturer may provide an indication of the quality of the item 134 and/or the manufacturer. As will be discussed in detail later, the message 140 may also include a response to a service request of a customer 102 from a manufacturer. Such a message 140 may indicate the quality of service provided by the manufacturer. It should be understood that various other data and/or activities between the customer and the manufacturer may be stored and analyzed by the electronic marketplace system 108.

The analysis results may then be utilized to generate information to facilitate customers 102 of the electronic marketplace system 108 to make purchase or other types of acquisition decisions in the future. For instance, the electronic marketplace system 108 may utilize the analysis results to generate a review commenting on the items 134 and/or the manufacturers. The electronic marketplace system 108 may also provide a ranking of the manufacturers based on the analysis results. The review, ranking and/or other indications of the quality of the items/manufacturers may be provided to the customer, in an item page for example, to enable a customer to make an educated purchase decision.

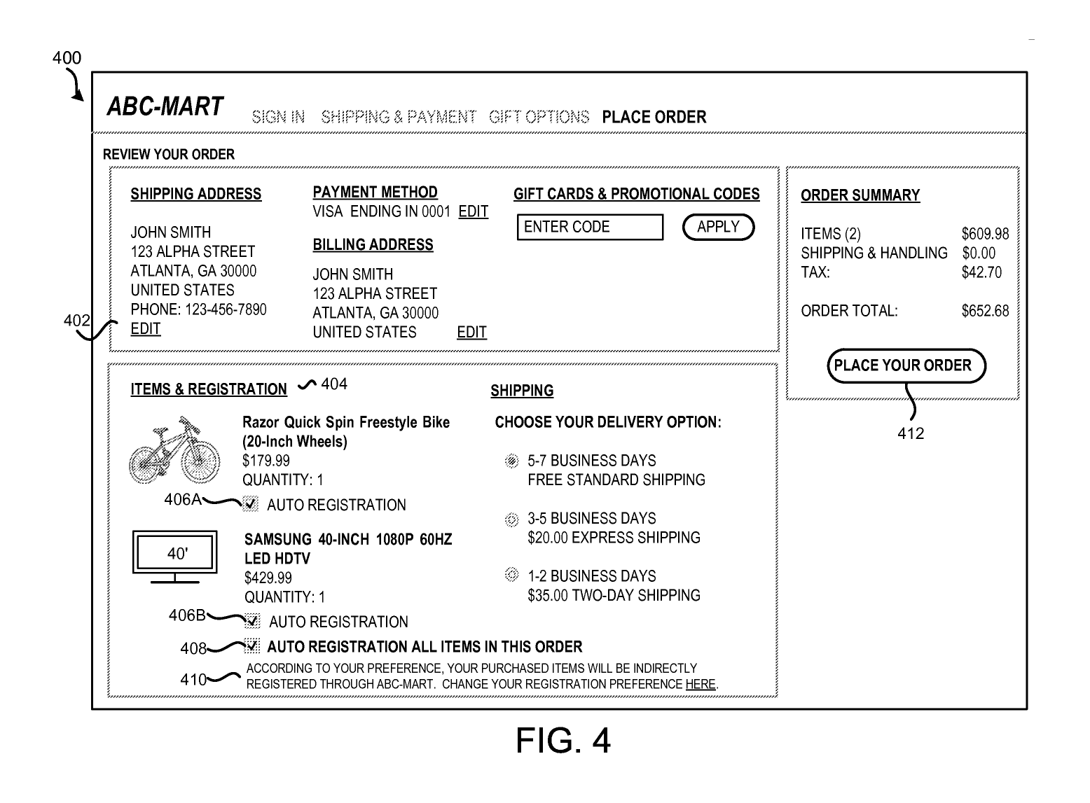

According to further embodiments, the item registration module 122 may also be configured to process a service request from a customer 102 regarding an item 134 purchased from and registered through the electronic marketplace system 108. The service request may be a request for item repair, item exchange, or item return and refund under the warranty provided by the manufacturer for the item 134. Based on the service request, the item registration module 122 may identify the corresponding manufacturer for the item 134 and retrieve any necessary information required by the manufacturer when submitting a service request, such as the name and type of the item 134, the model number of the item 134, the item ID 136, a proof of purchase for the item 134, and potentially other information. In addition, the item registration module 122 may check the service policy of the manufacturer, and submit the service request along with required information to the manufacturer system 128 according to the service policy to request the service. Additional details regarding processing item service requests will be described below with regard to FIG. 5.

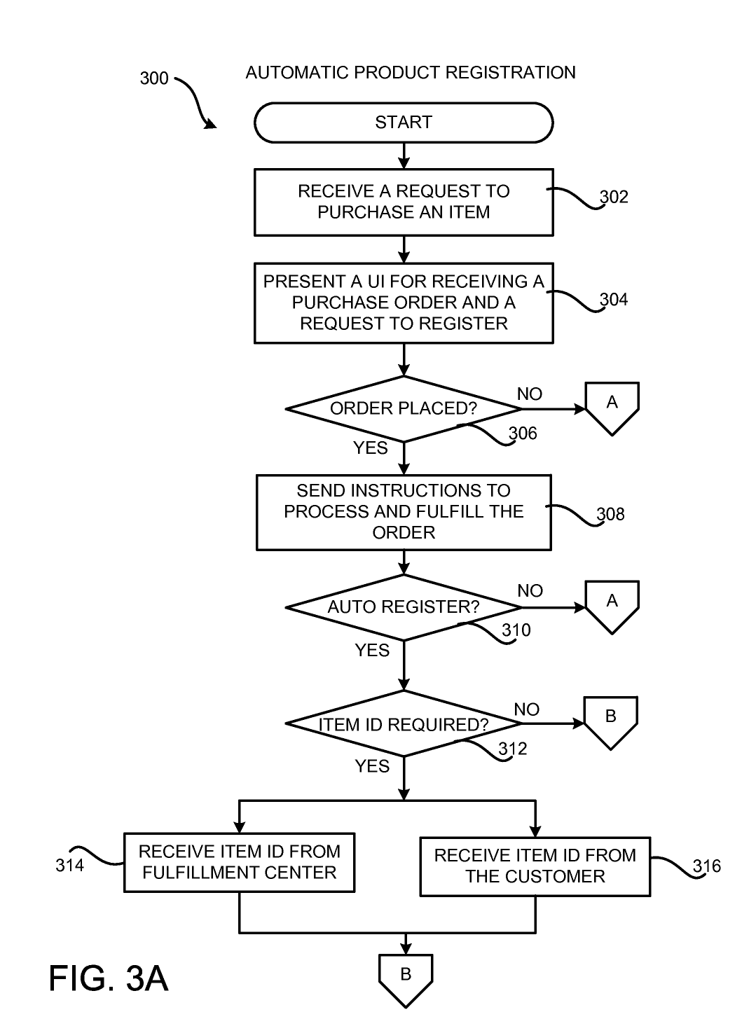

As will be discussed in detail later with regard to FIG. 3, when registering an item 134, a customer 102 may choose to use one of the two registration methods illustrated in FIGS. 1A and 1B. For example, the customer 102 may elect to register the item 134 directly with the manufacturer with the assistance of the electronic marketplace system 108 as shown in FIG. 1A or indirectly through the electronic marketplace system 108 as illustrated in FIG. 1B. The customer 102 may choose different registration methods for different items 134. Alternatively or additionally, the customer 102 may pre-select a registration method, such as through setting a registration preference in his/her user account with the electronic marketplace system 108, and may utilize the pre-selected registration method as the default registration method for all the items 134 contained in a purchase order. It should be understood that the above examples are merely illustrative and should not be construed as limiting. Various other ways for enabling a customer 102 to select a registration method may be employed.

Turning now to FIG. 2, additional details regarding the manufacturer data store 114 and the registration data store 142 will be provided. In particular, FIG. 2 illustrates a number of data elements stored in these data stores, according to embodiments presented herein. As briefly described above, the manufacturer data store 114 may store data associated with manufacturers whose items are offered for sale through the electronic marketplace system 108 and who are in agreement with the electronic marketplace to accept item registrations from the electronic marketplace system 108. This data may be stored as manufacturer data 202A-202N (which may be referred to as manufacturer data 202), each corresponding to a respective manufacturer.

As shown in FIG. 2, the manufacturer data 202 may contain basic information about the manufacturer, such as manufacturer name 204, and the contact information 206 of the manufacturer, and others. The manufacturer data 202 may further include registration submission information 208. As briefly discussed above, the item registration module 122 may submit registration instructions 138 to a manufacturer system 128 through an API exposed by the manufacturer system 128. In such a scenario, the registration submission information 208 may include, but is not limited to, a general description of the API call, the format of the API call, input and output of the API call, and/or any other information that may be utilized to submit the registration instructions 138 through the API. It should be understood that the registration instructions 138 may be submitted to the manufacturer system 128 in various other ways, and the registration submission information 208 may include the corresponding instructions for submitting the registration instructions 138.

The manufacturer data 202 for a manufacturer may further include item registration data 210A-210N (which may be referred to as item registration data 210) for items that are manufactured by the manufacturer and required for registration. For example, the item registration data 210 for an item 134 may contain an item name 212, an item model number 214, required information 216 for submitting the registration, and potentially other data. Different manufacturers may have different required information 216 for registering an item 134. For example, some manufacturers may only require a customer's name and electronic mail address in the item registration instructions, while other manufacturers may require or desire more detailed information about the customer to be submitted in the registration instructions 138, such as the telephone number of the customer, the age of the customer, shipping address of the customer and/or the income level of the customer.

Likewise, for different items, the required information 216 may be different. For instance, a name and a model number of an item 134 may be sufficient to register a toy item 134, whereas additional information, such as the type of the item, the UPC code, the serial number, and/or the date of manufacture may also be required to register a home appliance item. It will be appreciated that additional data elements may be contained in the manufacturer data 202 for a manufacturer and additional data elements may also be contained in the item registration data 210 for an item manufactured by the manufacturer beyond those described herein, and that not every data element described will be available for every manufacturer and every item manufactured by the manufacturer.

FIG. 2 further illustrates data elements maintained in the registration data store 142, and more specifically the registered item data 222A-222N (which may be referred to herein as registered item data 222) for items that have been indirectly registered through the electronic marketplace system 108. The registered item data 222 for a registered item 134 may include an item name 224, an item type/model 226, and a manufacturer 228 of the item 134. Since for one type/model of items, there may be multiple customers whose items have been registered, the registered item data 222 may further include registered customer data 230A-230N (which may be referred to herein as registered customer data 230), one for each registered customer.

The registered customer data 230 may contain basic information 232 of the registered customer, such as name, shipping address and contact information, and item ID 234, such as the serial number, of the registered item. The registered customer data 230 may further include customer preference 236 in receiving messages from the manufacturer of the registered item. For example, a customer may indicate in the customer preference 236 that he/she would like to receive from the manufacturer only messages concerning item safety, while other customers may also want to receive messages from the manufacturer regarding item promotion and/or discount. The registered customer data 230 may also include a preference for the form in which the messages are received, e.g., electronic mail, text message, regular mail, voicemail, etc. As briefly mentioned above, the customer preference 236 may be utilized by the item registration module 122 to filter messages 140 sent by the manufacturer before forwarding the messages 140 to the customer 102.

It should be understood that additional data elements may be contained in the registered item data 222 and the registered customer data 230 beyond those described herein, and that not every data element described will be available for every registered item and/or customer. In some implementations, information contained in the registered customer data 230, such as the customer basic information 232 and the customer preference 236 may be stored in a different data store, such as the customer profile data store 118, and a reference to the relevant data may be stored in the registered customer data 230 that may be utilized to retrieve the corresponding data. It should be further understood that while the registration data store 142 has been described to store item data for indirectly registered items 134, item data for directly registered items 134 may also be stored and utilized in a similar manner. It will also be appreciated by those skilled in that art that the registered customer data 230, or portions thereof, may instead be stored in association with the customer's account maintained by the electronic marketplace system 108 and retrieved from said account upon request.

FIGS. 3A and 3B illustrate a flow diagram showing an illustrative routine 300 for providing item registration services, according to one embodiment disclosed herein. In some implementations, the routine 300 is performed by the electronic marketplace system 108 described above in regard to FIGS. 1A and 1B. It should be appreciated, however, that the routine 300 might also be performed by other modules and/or components or other entities in the system illustrated in FIGS. 1A and 1B. The various operations illustrated in FIGS. 3A and 3B might also be performed by other systems, services, components, or combinations of these entities in other implementations.

It should also be appreciated that the logical operations described herein with respect to FIGS. 3A and 3B, and the other FIGS., may be implemented (1) as a sequence of computer implemented acts or program modules executed by a computing system and/or (2) as interconnected machine logic circuits or circuit modules within the computing system. The implementation of the various components described herein is a matter of choice dependent on the performance and other requirements of the computing system. Accordingly, the logical operations described herein are referred to variously as operations, structural devices, elements, or modules. These operations, structural devices, elements, and modules may include software, firmware, special purpose digital logic, and any combination thereof, that is executed by hardware. It should also be appreciated that more or fewer operations may be performed than shown in the FIGS. and described herein. These operations may also be performed in parallel, or in a different order than those described herein.

The routine 300 begins at operation 302, where a request to purchase an item 134 may be received from a customer 102 through a customer computing device 104. In response to receiving the request, the routine 300 proceeds to operation 304, where a user interface may be presented to the customer 102 through which the customer 102 may place an order 124 for purchasing the item 134. As briefly discussed above, the user interface may further enable the customer 102 to submit a request to automatically register the item 134 directly with a manufacturer of the item 134 or indirectly through the electronic marketplace system 108. An exemplary user interface that enables a customer to submit a request to register the item 134 along with an order 124 to purchase items 134 is illustrated in FIG. 4 and will described in detail below.

From operation 304, the routine 300 proceeds to operation 306, where a determination may be made as to whether the customer 102 has placed the purchase order 124 for the item 134. If it is determined that the customer has placed the order to purchase the item 134, the routine 300 proceeds to operation 308, where instructions are sent to the fulfillment center to process the order and to fulfill the purchase order 124.

The routine 300 then proceeds to operation 310, where it is determined whether the customer 102 has requested to automatically register the items contained in the purchase order 124. If the customer 102 has requested to automatically register the items, the routine 300 proceed to operation 312, where it is determined whether an item ID 136 is required to register the item 134. If an item ID 136 is required, the routine 300 may proceed to operations 314 or operation 316 to obtain the item ID 136. At operation 314, the item ID 136 may be received from a fulfillment center where the item ID 136 may be obtained by scanning the item ID 136 printed on the packaging of the item 134. At operation 316, the item ID 136 may be received from the customer 102 after the customer 102 has received the item 102 and has returned to the electronic marketplace to input the item ID 136.

From operation 314 or operation 316, the routine 300 proceeds to operation 318 where it is determined whether the customer 102 has requested to directly register the item 134 with the assistance of the electronic marketplace system 108 or indirectly register the item 134. If it is determined that the customer 102 has requested assisted direct registration for the item 134 with the manufacturer, the routine 300 proceeds to operation 324 where registration instructions 138 is generated based on the personal information of the customer 102. If, at operation 318, it is determined that the customer 102 has requested to indirectly register the item 134 with the manufacturer, the routine 300 proceeds to operation 320 where registration instructions 138 is generated by replacing the customer's information with the electronic marketplace's information. Next, at operation 322, the registration information and the customer information may be stored in the registration data store 142.

From operation 322 or operation 324, the routine 300 proceeds to operation 326, where the generated registration instructions 138 may be sent to the corresponding manufacturer system 128. Next, at operation 328, a confirmation may be received from the manufacturer system 128 to confirm that the item 134 has been registered, and the confirmation may be further forwarded to the customer 102. In some embodiments, the manufacturer system 128 may also assign a unique identifier to the registration transaction following receipt of the registration instructions 138 and send such unique identifier as part of or in addition to the confirmation. From operation 328, or from operation 310 when it is determined that no item in the order is requested for registration, the routine 300 proceeds to operation 330, where it ends.

It should be appreciated that in some implementations, various operations described above may be performed differently or may not be performed at all. For example, for indirect registration, the electronic marketplace system 108 may process the requests for automatic registration in batch and send registration instructions 138 to register multiple items with the manufacturer in operation 326. Alternatively, the electronic marketplace and the manufacturer may have reached an agreement that each item sold through the electronic marketplace system 108 is to be automatically registered with the manufacturer through indirect registration. In such a scenario, there may be no need to send the registration instructions 138 for the indirect registration to the manufacturer as described in operation 326. Similarly, the confirmation of registration sent to the customer 102 as discussed in operation 328 may be generated by the electronic marketplace system 108, rather than received from the manufacturer. In some implementations, there might be no confirmation of registration sent to the customer 102.

FIG. 4 is a pictorial diagram illustrating a user interface (“UI”) 400 provided by the electronic marketplace system 108 that enables a customer 102 to submit a request to automatically register an item 134 along with a purchase order 124 for items 134. The UI 400 shown in FIG. 4 includes a field 402 where the customer's information such as the name, the shipping address, the payment information, and the phone number of the customer are shown and may be edited.

The UI 400 further includes an “items & registration” field 404, wherein items 134 to be purchased in the current order 124 are listed. UI controls 406A and 406B (which may be referred to as UI control 406) are included in the field 404 to enable the customer 102 to request automatic registration for each of the items 134. By selecting a UI control 406, a request to automatically register the corresponding item will be generated after the customer 102 places the order 124. The UI 400 further includes a UI control 408 that enables the customer 102 to request automatic registration for all the items included in the purchase order 124 through a single selection action on the UI control 408.

As discussed above, the customer 102 may choose to directly register the items 134 with the manufacturer with the assistance of the electronic marketplace system 108 using his/her identity information as maintained by the electronic marketplace system 108. Alternatively, the customer 102 may select indirect registration wherein the electronic marketplace system 108 submits item registration instructions 138 to the manufacturer system 128 without releasing the identify information of the customer. The selection of the registration method may be pre-set in the customer preference 236 stored in the registration data store 142, in the customer profile data store 118 or in an account for the customer maintained by the electronic marketplace system 108. A message field 410 may be further included in the UI 400 to explain a current selection of the registration mechanism made by the customer 102 through the customer preference 236 and may enable the customer 102 to modify the selection. The UI 400 further includes a UI control 412 which when selected by the customer 102 will cause the order 124 to be submitted along with registration requests, if there is any.

It should be appreciated that while FIGS. 3A, 3B and 4 describe an example user interface that is presented for a customer 102 to place a purchase order 124 and to request automatic registration, separate user interfaces may be generated and presented to the customer 102 to achieve such functionality. By way of example, and not limitation, a user interface dedicated to submitting registration instructions may be presented to the customer 102 before a place-order user interface is presented. Alternatively, the registration request user interface may be presented after the customer 102 has placed the purchase order 124.

It should also be appreciated that a customer 102 may request item registration through various other methods and at various points of time. For example, the user may request to register an item 134 after the item 134 has been purchased and delivered to the customer 134. Since the electronic marketplace system 108 may keep records for transactions occurred therein, item/customer information 126 may be retrieved from the transaction records at almost any time. As such, the customer 102 may request a registration of an item 134 that he has purchased through the electronic marketplace system 108 by, for example, simply providing the order number to the electronic marketplace system 108. Alternatively, or additionally, a customer 102 may log into his/her user account, locate the purchase order that contains the item 134 to be registered, and request the registration for such an item 134 from within the user account. Other ways of requesting item registration may be implemented and provided to the customer 102.

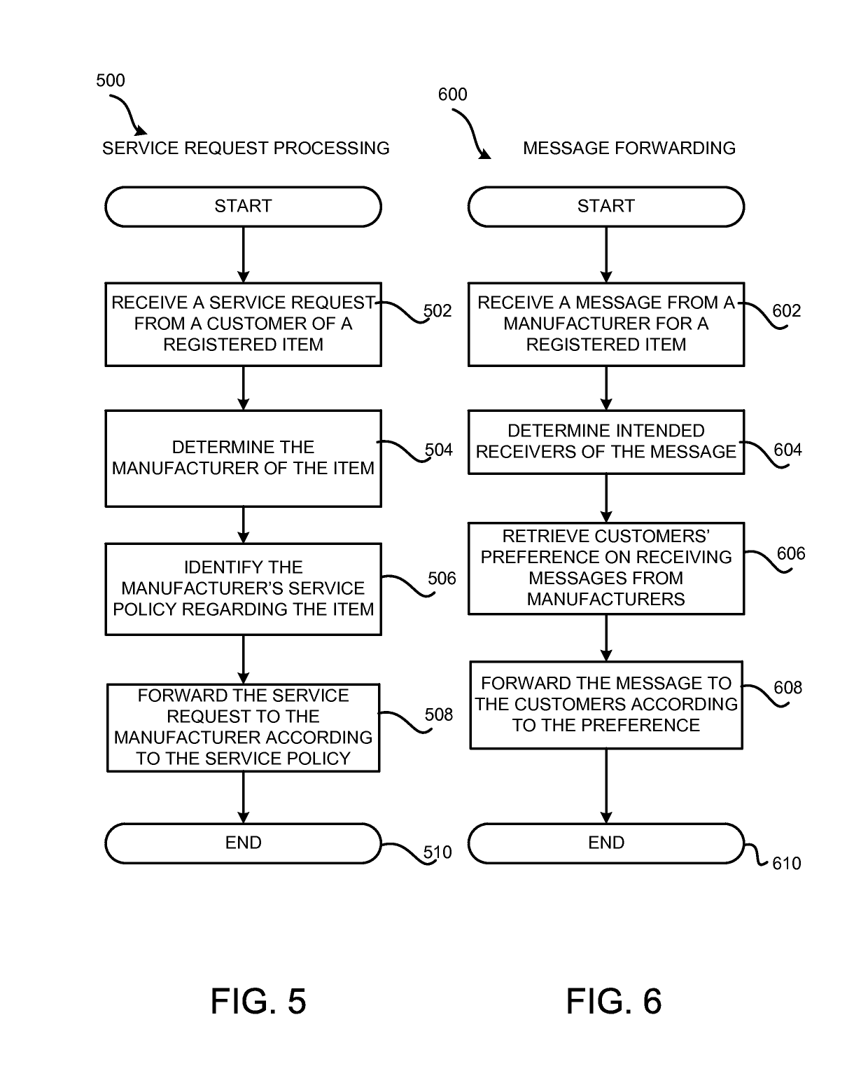

FIGS. 5 and 6 are flow diagrams illustrating additional services provided by the electronic marketplace system 108 related to item registration. Specifically, FIG. 5 illustrates a process for handling a service request from a registered customer 102 regarding a registered item 102, according to one embodiment disclosed herein. FIG. 6 is a flow diagram showing aspects of forwarding a message from a manufacturer of an item 134 to registered customers 102. In some implementations, the routines 500 and 600 are performed by the item registration module 122 described above in regard to FIGS. 1A and 1B. It should be appreciated, however, that the routines 500 and 600 might also be performed by other modules and/or components or other entities in the electronic marketplace system 108 illustrated in FIGS. 1A and 1B. The various operations illustrated in FIGS. 5 and 6 might also be performed by other systems, services, components, or combinations of these entities in other implementations.

The routine 500 starts at operation 502, where a service request might be received from a customer 102 regarding a registered item 134. As discussed above, the service request may be a request for item repair, item exchange, or item return and refund under a warranty provided by the manufacturer for the item 134. The routine 500 then proceeds to operation 504, where the item registration module 122 may determine the corresponding manufacturer of the item 134 based on the information contained in the service request.

Next, at operation 506, the item registration module 122 may identify the manufacturer's service policy regarding the item 134 and retrieve necessary information required by the manufacturer when submitting a service request, such as the name and type of the item 134, the model number of the item 134, the item ID 136 of the item 134, a proof of purchase for the item 134, and potentially other information. From operation 506, the routine 500 proceeds to operation 508 where an updated service request including information required by the manufacturer may be generated and submitted to the manufacturer system 128 according to the service policy to request the service for the item 134. The routine then proceed to operation 510, where it ends.

The routine 600 starts at operation 602, where a message 140 regarding an item 134 is received from the manufacturer of the item 134 through the manufacturer system 128. As discussed briefly above, the message 140 may be a safety notification regarding the item 134, such as a recall notification, an item promotion announcement, an advertisement, and/or other message that is related to the item 134. If a service request for the item 134 has been submitted to the manufacturer system 128 for a customer 102 as discussed above in regard to FIG. 5, the message 140 may be a response to the submitted service request. It should be understood that various other messages 140 may be received from the manufacturer through the manufacturer system 128.

From operation 602, the routine 600 proceeds to operation 604, where the item registration module 122 may determine the customers 102 to whom the manufacturer intends to send the message 140. For example, if the message 140 is a recall announcement, the intended receivers of the message 140 may include all the customers 102 who purchased the item 134. If the message 140 is a response to a request from a customer 102, the intended receiver of the message may be the customer 102.

Once the intended receivers of the message 140 are identified, the routine 600 then proceeds to operation 606, where the customer preference 236 in receiving messages 140 from the manufacturer of the registered item 134 may be retrieved from the registration data store 142 and examined. Next, at operation 608, the message 140 may be forwarded to customers whose customer preference 236 indicates that the customers are willing to receive such a message 140. From operation 608, the routine 600 proceeds to operation 610, where it ends.

It should be appreciated that the electronic marketplace system 108 may provide additional services related to item registration beyond those described above. For example, the electronic marketplace system 108 may provide functionality that facilitates a customer 102 to manage item registrations in his/her user account, such as providing access to warranty policy documents for various items registered for the customer 102, keeping track of warranty expiration dates for the items, offering extended warranty to the customer 102 and the like. The electronic marketplace system 108 may further offer a service helping a customer 102 to determine the scope of the warranty and then provide suggestions as to the actions to take when damage occurs to an item 134, thereby generating a proper service request to the manufacturer.

It can be seen that by providing various services related to item registration, the electronic marketplace system 108 may offer a united tool for a customer 102 to manage the item registration for various items that have been purchased by the customer 102. The customer 102 may also be able to take full advantage of item registration without the efforts in collecting and entering numerous information required in a traditional item registration mechanism nor the concern of leaving customer's identify information in unwanted hand that typically deters a customer to register a purchase item.

To manufacturers, the item registration services provided by the electronic marketplace system 108 may significantly increase the registration rate. Although some of the items may be registered without obtaining the identity information of the purchasers, the manufacturers may still be able to obtain some statistical data regarding item registration. In addition, messages, including item promotion announcements and advertisements may be delivered to those end users whom the manufacturers may be otherwise unable to reach. In some embodiments, the electronic marketplace system 108 may provide, with the consent from the customers 102, non-identity information to the manufacturers, such as the rough geographic location of each individual customer 102, the age range of individual customer 102, the gender of individual customer 102, and the like. Alternatively, or additionally, statistical data for a group of customers 102 may be provided by the electronic marketplace system 108 to the manufacturer, such as the distribution of the customers' ages, genders, locations and so on. By doing so, more valuable information may be provided to manufacturers without releasing the identity of the customer 102.

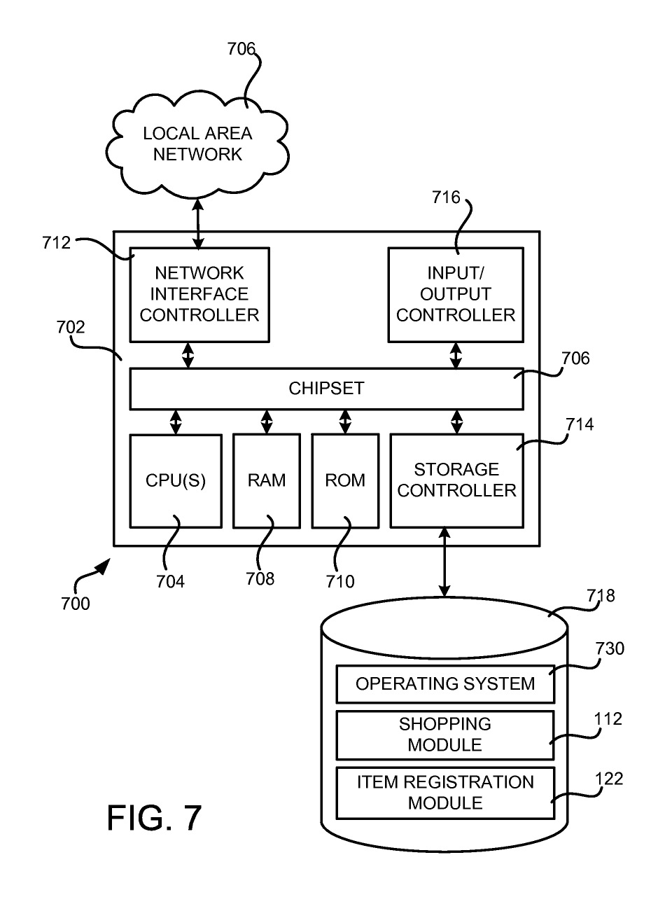

FIG. 7 shows an example computer architecture for a computer 700 capable of executing program modules for providing item registration services in the manner described above. The computer architecture shown in FIG. 7 illustrates a conventional server computer, workstation, desktop computer, laptop, tablet, network appliance, personal digital assistant (“PDA”), electronic book reader, wearable computing device, digital cellular phone, or other computing device, and may be utilized to execute any of the software components/modules presented herein. For example, the computer architecture shown in FIG. 7 may be utilized to execute software modules for providing the electronic marketplace system 108 described above. The computer architecture shown in FIG. 7 might also be utilized to implement the customer computing device 104, a computing device that executes the item information collecting system 132, application servers 110 in the electronic marketplace system 108, or any other of the computing systems described herein.

The computer 700 includes a baseboard 702, or “motherboard,” which is a printed circuit board to which a multitude of components or devices may be connected by way of a system bus or other electrical communication paths. In one illustrative embodiment, one or more central processing units (“CPUs”) 704 operate in conjunction with a chipset 706. The CPUs 704 may be standard programmable processors that perform arithmetic and logical operations necessary for the operation of the computer 700.

The CPUs 704 perform operations by transitioning from one discrete, physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits, including registers, adders-subtractors, arithmetic logic units, floating-point units, and the like.

The chipset 706 provides an interface between the CPUs 704 and the remainder of the components and devices on the baseboard 702. The chipset 706 may provide an interface to a RAM 708, used as the main memory in the computer 700. The chipset 706 may further provide an interface to a computer-readable storage medium such as a read-only memory (“ROM”) 710 or non-volatile RAM (“NVRAM”) for storing basic routines that help to startup the computer 700 and to transfer information between the various components and devices. The ROM 710 or NVRAM may also store other software components necessary for the operation of the computer 700 in accordance with the embodiments described herein.

The computer 700 may operate in a networked environment using logical connections to remote computing devices and computer systems through a network, such as the local area network 706. The chipset 706 may include functionality for providing network connectivity through a NIC 712, such as a gigabit Ethernet adapter. The NIC 712 is capable of connecting the computer 700 to other computing devices over the network 706. It should be appreciated that multiple NICs 712 may be present in the computer 700, connecting the computer to other types of networks and remote computer systems.

The computer 700 may be connected to a mass storage device 718 that provides non-volatile storage for the computer. The mass storage device 718 may store system programs, application programs, other program modules, and data, which have been described in greater detail herein. The mass storage device 718 may be connected to the computer 700 through a storage controller 714 connected to the chipset 706. The mass storage device 718 may consist of one or more physical storage units. The storage controller 714 may interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 700 may store data on the mass storage device 718 by transforming the physical state of the physical storage units to reflect the information being stored. The specific transformation of physical state may depend on various factors, in different implementations of this description. Examples of such factors may include, but are not limited to, the technology used to implement the physical storage units, whether the mass storage device 718 is characterized as primary or secondary storage, and the like.

For example, the computer 700 may store information to the mass storage device 718 by issuing instructions through the storage controller 714 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 700 may further read information from the mass storage device 718 by detecting the physical states or characteristics of one or more particular locations within the physical storage units.

In addition to the mass storage device 718 described above, the computer 700 may have access to other non-transitory computer-readable storage media to store and retrieve information, such as program modules, data structures, or other data. It should be appreciated by those skilled in the art that computer-readable storage media is any available media that provides for the non-transitory storage of data and that may be accessed by the computer 700.

By way of example, and not limitation, non-transitory computer-readable storage media may include volatile and non-volatile, removable and non-removable media implemented in any method or technology. Non-transitory computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

The mass storage device 718 may store an operating system 730 utilized to control the operation of the computer 700. The mass storage device 718 may store other system or application programs and data utilized by the computer 700, such as the shopping module 112, the item registration module 122, and/or any of the other software modules and data described above. The mass storage device 718 might also store other programs and data not specifically identified herein.

In one embodiment, the mass storage device 718 or other non-transitory computer-readable storage media is encoded with computer-executable instructions that, when loaded into the computer 700, transform the computer from a general-purpose computing system into a special-purpose computer capable of implementing the embodiments described herein. These computer-executable instructions transform the computer 700 by specifying how the CPUs 704 transition between states, as described above. According to one embodiment, the computer 700 has access to computer-readable storage media storing computer-executable instructions which, when executed by the computer 700, perform the routines described above with regard to FIGS. 3A, 3B, 5 and/or 6. The computer 700 might also include computer-readable storage media for performing any of the other computer-implemented operations described herein.

The computer 700 may also include one or more input/output controllers 716 for receiving and processing input from a number of input devices, such as a keyboard, a mouse, a touchpad, a touch screen, an electronic stylus, or other type of input device. Similarly, the input/output controller 716 may provide output to a display, such as a computer monitor, a flat-panel display, a digital projector, a printer, a plotter, or other type of output device. It will be appreciated that the computer 700 may not include all of the components shown in FIG. 7, may include other components that are not explicitly shown in FIG. 7, or may utilize an architecture completely different than that shown in FIG. 7.

Based on the foregoing, it should be appreciated that technologies for providing item registration services have been presented herein. Moreover, although the subject matter presented herein has been described in language specific to computer structural features, methodological acts, and computer readable media, it is to be understood that the embodiments defined in the appended claims are not necessarily limited to the specific features, acts, or media described herein. Rather, the specific features, acts, and media are disclosed as example forms of implementing the claims.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

Conjunctive language such as the phrase “at least one of X, Y and Z,” unless specifically stated otherwise, is otherwise understood with the context as used in general to convey that an item, term, etc. may be either X, Y, or Z, or a combination thereof. Thus, such conjunctive language is not generally intended to imply that certain embodiments require at least one of X, at least one of Y, and at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted or executed out of order from that shown or discussed, including substantially concurrently or in reverse order, depending on the functionality involved as would be understood by those skilled in the art.

The subject matter described above is provided by way of illustration only and should not be construed as limiting. Furthermore, the claimed subject matter is not limited to implementations that solve any or all disadvantages noted in any part of this disclosure. Various modifications and changes may be made to the subject matter described herein without following the example embodiments and applications illustrated and described, and without departing from the true spirit and scope of the present disclosure, which is set forth in the following claims.

What is claimed is:

1. A computer-readable, non-transitory storage medium storing computer executable instructions that, when executed by one or more computing devices, configure the one or more computing devices to perform operations comprising:
receiving a request from a customer computing device to purchase an item available from an electronic marketplace that is not owned or under the control of a manufacturer of the item;
causing a user interface to be presented at the customer computing device that enables a customer to submit an order to purchase the item from the electronic marketplace and to submit a request to register the item with the manufacturer of the item through the electronic marketplace;
receiving the request to register the item that was submitted by the customer;
receiving item data that uniquely identifies the item, and customer data that identifies at least one of:
the electronic marketplace as a registration proxy for the customer, or
the customer;
generating a registration instruction including the item data and the customer data;
sending the registration instruction to a computing system associated with a manufacturer of the item to register the item; and
receiving a confirmation of registration for the item from the computing system associated with the manufacturer.

2. The computer-readable, non-transitory storage medium of claim 1, wherein the customer data identifies the electronic marketplace as a registration proxy for the customer, and wherein the operations further comprise:
receiving a service request for the item from the customer; and
forwarding the service request to the computing system associated with the manufacturer of the item.

3. The computer-readable, non-transitory storage medium of claim 2, wherein the operations further comprise:
collecting additional information required by the manufacturer for submitting the service request; and
forwarding the additional information along with the service request to the computing system associated with the manufacturer.

4. The computer-readable, non-transitory storage medium of claim 1, wherein the item data is received from at least one of:
a fulfillment center where the item is prepared for delivery to the customer, or
the customer.

5. The computer-readable, non-transitory storage medium of claim 1, wherein the customer data is received from the electronic marketplace.

6. The computer-readable, non-transitory storage medium of claim 1, wherein the customer data identifies the electronic marketplace as a registration proxy for the customer, and wherein the operations further comprise:
receiving a message from a second manufacturer, the message specifying a particular item that has been registered with the second manufacturer;
identifying a customer who registered the particular item through the electronic marketplace; and
forwarding the message to the second customer.

7. A computing system comprising:
a processor; and
a non-transitory computer-readable storage medium having executable instructions stored thereupon that, when executed by the processor, cause the computing system to at least:
receive an order to acquire an item available from an electronic marketplace;
receive a request to automatically register the item through the electronic marketplace with a manufacturer of the item, wherein the electronic marketplace is not associated with the manufacturer;
generate a registration instruction comprising item data describing the item to be registered and registrant data describing an identity of a registrant for the item, wherein the registrant data is maintained by the electronic marketplace; and
send the registration instruction to a computer system associated with the manufacturer of the item.

8. The computing system of claim 7, wherein the non-transitory computer-readable storage medium has further executable instructions stored thereupon which, when executed by the processor, cause the computing system to at least obtain an identification of the item that uniquely identifies the item, and to include the identification of the item in the item data of the registration instruction.

9. The computing system of claim 8, wherein the identification of the item is obtained from at least one of:
a fulfillment center where the item is prepared for delivery to the customer, or the registrant when the registrant is in possession of the item.

10. The computing system of claim 8, wherein the registrant is a customer who submitted the order to acquire the item.

11. The computing system of claim 7, wherein the registrant is the electronic marketplace who is registering the item on behalf of the customer.

12. The computing system of claim 11, wherein the non-transitory computer-readable storage medium has further executable instructions stored thereupon which, when executed by the processor, cause the computing system to at least:
receive a service request from the customer, the service request specifying a service to be performed by the manufacturer with respect to the item;
retrieve additional data associated with the item; and
forward the service request along with the additional data associated with the item to the manufacturer to request the service for the item on behalf of the customer.

13. The computing system of claim 11, wherein the non-transitory computer-readable storage medium has further executable instructions stored thereupon which, when executed by the processor, cause the computing system to at least:
receive a message from a second manufacturer, the message specifying a particular item that has been registered with the second manufacturer;
identify a second customer who has previously registered the particular item; and
forward the message to the second customer.

14. A computer-implemented method comprising:
causing, by one or more computing devices implementing an electronic marketplace, presentation of a user interface that enables submission of a request to register an item ordered by a customer via the electronic marketplace with a manufacturer of the item;
receiving, at the one or more computing devices, the submission of the request to register the item;
generating, by the one or more computing devices, a registration instruction including:
item data describing the item, and
customer data that identifies at least one of:
the customer, or
the electronic marketplace as a registration proxy for the customer; and
sending, by the one or more computing devices, the registration instruction to a computer system associated with the manufacturer of the item to register the item.

15. The computer-implemented method of claim 14, further comprising:
receiving a service request for the item; and
forwarding the service request to the computer system associated with manufacturer of the item.

16. The computer-implemented method of claim 15, further comprising:
collecting additional information required by the manufacturer for submitting the service request; and
forwarding the additional information along with the service request to the computing system associated with the manufacturer.

17. The computer-implemented method of claim 14, wherein the item data comprises an identification of the item that uniquely identifies the item.

18. The computer-implemented method of claim 17, wherein the identification of the item is received from at least one of:
a fulfillment center where the item is prepared for delivery to the customer, or
the customer.

19. The computer-implemented method of claim 14, further comprising:
receiving a message from a second manufacturer, the message specifying a particular item that has been registered with the second manufacturer;
identifying a second customer who registered the particular item; and
forwarding the message to the second customer.

20. The computer-implemented method of claim 14, wherein the request to register the item is selected for submission through a single action performed by the customer on the user interface.
